(19) United States
(12) Patent Application Publication
(10) Pub. No.: US 2002/0082959 A1
(43) Pub. Date: Jun. 27, 2002

(54) Method, apparatus and article for tracking replacement part information

(76) Inventors: Daniel E. Barnard, Marietta, GA (US); Christopher M. Killian, Broadalbin, NY (US)

Correspondence Address: PERKINS COIE LLP, PATENT-SEA, P.O. BOX 1247, SEATTLE, WA, 98111-1247, US

(21) Appl. No.: 09/750,485

(22) Filed: Dec. 27, 2000

(51) Int. Cl. G06F 17/60

(52) U.S. Cl. 705/29

(57) ABSTRACT

Legacy parts information is made accessible via a database employing hierarchical parts groupings, distribution codes, categories and plain language parts titles and or descriptions.

### TECHNICAL FIELD

This invention is generally related to the tracking of information regarding replacement parts, and particularly to the provision of replacement part information to assist in the identification and/or sales of replacement parts.

### BACKGROUND

The tracking of parts can be an extremely complex and time consuming activity for a company. This is particularly a problem for large manufacturing companies which may produce many thousands of different machines over the course of time, with each machine consisting of thousands of individual parts. The company may design and build these machines at a variety of different company locations. The company may manufacture some machines for a relatively short period of time, while other machines may be manufactured with, or without change, over an extended period of time. Typically, a company will, for contractual or other reasons, wish to supply replacement parts for some or all of the different machines it has sold. The company may make the replacement parts available only within the company, or may make the parts available to outside vendors and/or customers.

Typically, the designers and engineers developing a machine will specify engineering parts lists, such as master parts lists or drawing lists. These lists may, or may not, be in computer-readable form. Over time, the engineering parts lists may evolve into manufacturing oriented parts lists or bill of material. Often, data is lost and/or significantly modified as the lists evolve. Typically, the lists will consistently carry through at least one identifier as they evolve. For example, a master parts list item number or drawing list line number, and/or a keyword, may be consistently represented between the original master parts list, drawing list or bill of material.

### SUMMARY

In one aspect, each of a number of unique parts for a first set of legacy machine parts information is identified by a respective part identifier, an entry is created in a computer searchable database corresponding to the part for each of the identified unique parts, and a category identifier is provided in the computer searchable database for each of the identified unique parts that identifies at least one machine subassembly to which the part belongs.

In another aspect, each of a number of unique parts for a first set of legacy machine parts information is identified by a respective part identifier, an entry is created in a computer searchable database corresponding to the part for each of the identified unique parts, and a distribution code is provided in the computer searchable database for each of the identified unique parts that identifies at least one salable unit to which the part belongs.

In yet another aspect, each of a number of unique parts for a first set of legacy machine parts information is identified by a respective part identifier, an entry is created in a computer searchable database corresponding to the part for each of the identified unique parts, and a plain language title is provided in the computer searchable database for each of the identified unique parts that identifies the part.

In a further aspect, a database is provided of parts information computer searchable by plain language parts descriptions for a plurality of parts comprising one or more machines, and including a distribution code in the computer searchable database for each of the parts that identifies at least one salable unit to which the part belongs, and a user interface is provided for accessing the parts information by way of the plain language parts descriptions or a menu of categories for a broader display of salable parts and or assemblies.

In yet a further aspect, a search request is received in the form of a plain language parts description, at least one machine part that corresponds to the received plain language parts description is automatically located in a computer searchable database of machine parts, and item information is transmitted for at least one salable item that includes the located machine part and at least one other machine part.

### BRIEF DESCRIPTION OF DRAWINGS

In the drawings, identical reference numbers identify similar elements or acts. The size and relative positions of elements in the drawings are not necessarily drawn to scale. For example, the shapes of various elements are not drawn to scale, and some of these elements are arbitrarily enlarged and positioned to improve drawing legibility. Further, the particular shapes of elements, as drawn, are not intended to convey any information regarding the actual shape of the particular elements, and have been solely selected for their ease and recognition in the drawings.

FIG. 1 is a schematic drawing showing an environment in which an embodiment of the invention can operate, including a network coupling a number of client computing systems and a server computing system.

FIG. 2 is a high level system block diagram showing various hardware elements of the client computing systems of FIG. 1.

FIG. 3 is a schematic diagram of a bill of materials data structure, a translation data structure and a response data structure, each illustrated in table form.

FIG. 4 is a flow diagram illustrating a method of providing legacy parts information in a computer-searchable form.

FIG. 5 is a flow diagram illustrating a method of accessing parts information.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with computers, computer networks, data structures, databases and networks such as the Internet, have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

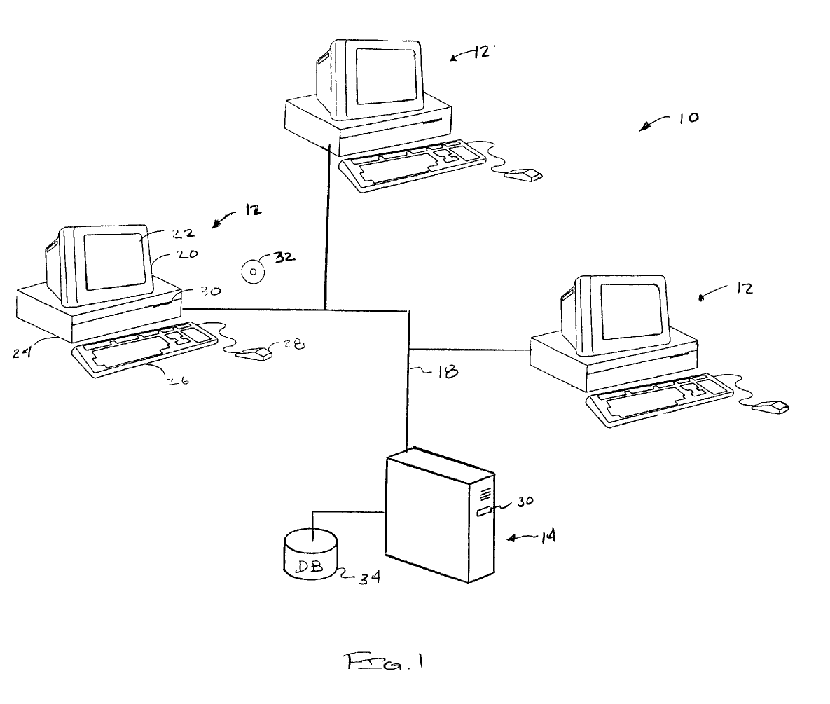

FIG. 1 shows a parts identification and tracking system 10 including a number of client computing systems 12 and a server computing system 14 that communicate over a network, such as the World Wide Web portion of the Internet 18. The client computing systems 12 each include a display 20, screen 22, cabinet 24, keyboard 26 and mouse 28. The mouse 28 can have one or more user selectable buttons for interacting with a graphical user interface (“GUI”) displayed on the screen 22. The cabinet 24 includes a slot 30 for receiving computer-readable media, such as a CD-ROM disk 32. Although the computer-readable media is represented as a CD-ROM disk 32, the parts identification and tracking system 10 can employ other computer-readable media, including but not limited to, floppy disks, tape, flash memory, system memory, and hard drives.

The server computing system 14 includes a cabinet 24 having a slot 30 for receiving computer-readable media, such as a CD-ROM disk similar to the CD-ROM disk 32. The server computing system 14 can optionally include a display, screen, keyboard, and/or mouse as described above. The server computing system 14 also includes a server database 34. The server database 34 is shown as being external to the cabinet 24 for ease of representation in the drawings, although in many embodiments the server database 34 can be located within the cabinet 24.

The network 18 can take the form of any conventional network, such as one or more local area networks (“LANs”), wide area networks (“WANs”), and/or extranets, intranets, or the Internet.

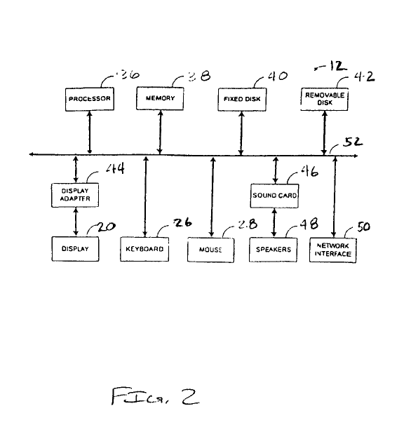

FIG. 2 shows a system block diagram of the client computing systems 12 used in executing an illustrated embodiment of the present invention. As in FIG. 1, the client computing systems 12 each include the display 20, keyboard 26 and mouse 28. Additionally, each of the client computing systems 12 can include subsystems, such as a processor 36, system memory 38, fixed persistent memory 40, media drive 42, display adapter 44, sound card 46, speakers 48, and network interface 50. Arrows 52 represent the system bus architecture of the client computing systems 12.

The client computing systems 12 can take any of a variety of forms, such as a micro- or personal computer, a mini-computer, a workstation, or a palm-top or hand-held computing appliance. The processor 36 can take the form of any suitable microprocessor, for example, a Pentium II, Pentium III, Power PC 603 or Power PC 604 processor. The system memory 38 can take the form of random access memory (“RAM”) or other dynamic storage that temporarily stores instructions and data for execution by the processor 36. The fixed persistent memory 40 can take the form of a hard drive or other nonvolatile computer-readable media. The media drive 42 can take the form of a CD-ROM reader, DVD reader, optical disk reader, floppy disk reader, or other similar device that reads instructions and/or data from computer-readable media.

While not shown in detail, the server computing system 14 can have a similar structure to the client computing systems 12, as shown in FIG. 2. In practice, the server computing system will typically take the form of a Web server, the details of which are commonly understood by those skilled in the art. The server computing system 14 employs database software, such as structured query language (“SQL”) software, to store and retrieve data within the server database 34.

The computing systems 12, 14 are illustrative of the numerous computing systems suitable for use with the present invention. Other suitable configurations of computing systems will be readily apparent to one of ordinary skill in the art. Other configurations can include additional subsystems, or fewer subsystems, as is suitable for the particular application. For example, a suitable computing system 12, 14 can include more than one processor 36 (i.e., a multiprocessor system) and/or a cache memory. The arrows 52 are illustrative of any interconnection scheme serving to link the subsystems. Other suitable interconnection schemes will be readily apparent to one skilled in the art. For example, a local bus could be utilized to connect the processor 36 to the system memory 38 and the display adapter 34.

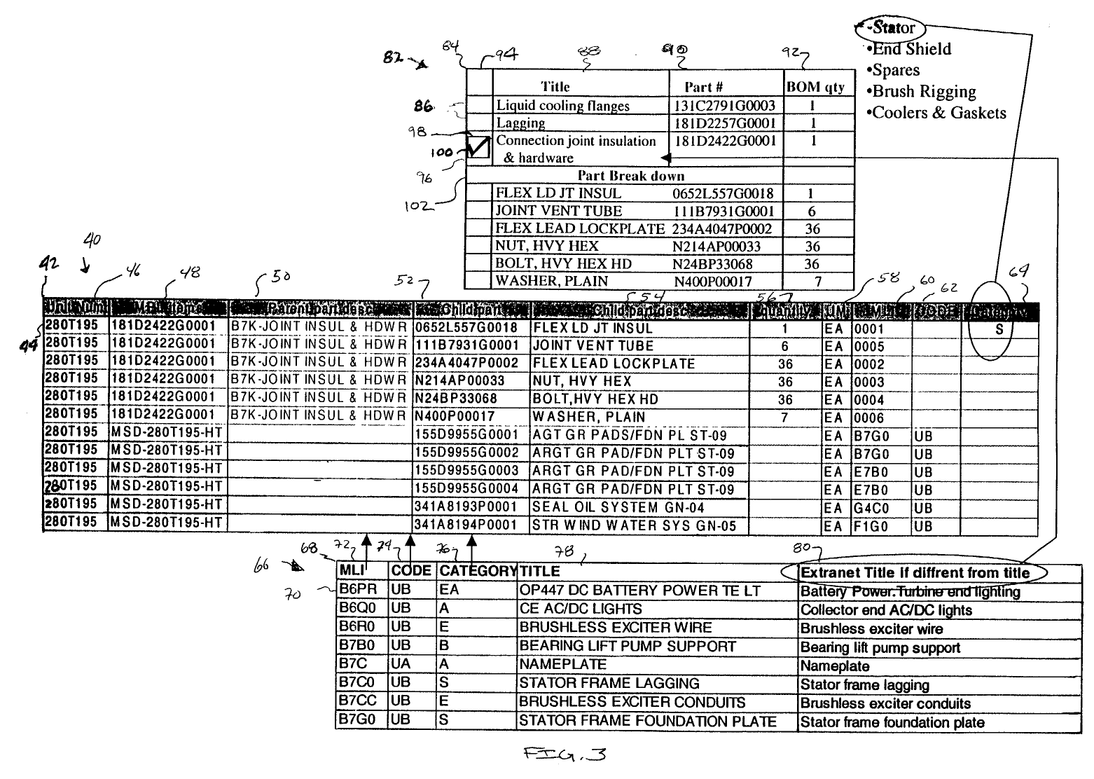

FIG. 3 shows a portion of a bill of material data structure 40 for a particular machine, such as a power turbine. The bill of material data structure 40 is illustrated as a bill of material table 42 including parts information for the various parts of the machine, although other formats may be suitable. The bill of material data structure 40 can take the form of an computer-readable file resulting directly from the design/manufacturing process, or can be an computer-readable file populated from a prior existing set of legacy data, such as by typing or scanning data from a paper bill of material.

The bill of material table 42 includes a number of rows 44 corresponding to the individual parts and/or groups of parts forming the machine. The bill of material table 42 includes a number of columns for detailing information regarding each of the parts. For example, a “unit identifier” column 46 (“Unit Num”) contains an identifier such as a serial number for a unit to which the corresponding part belongs. The unit identifier can, for example, identify a model of machine. A “parent” column 48 (“MPL items”) identifies a assembly or sub-assembly to which the part belongs, if any. For example, a joint vent tube is a component of a connection joint insulation and hardware assembly. A “parent part description” column 50 (“Parent part desc”) provides a brief textual description of the assembly or sub-assembly. Often, the designers and engineers create the brief textual description, and intend the description only for internal use. Thus, the brief textual description is typically cryptic, employing jargon such as abbreviations and acronyms that are not readily understood by those who are not intimately familiar with the machine. For example, the textual description for a connection joint insulation and hardware sub-assembly may be “B7K-JOINT INSUL & HDWR.”

A “child part identifier” column 52 (“child part”) contains an identifier such as a serial number identifying the part to which the row corresponds. A “child part description” column 54 (“child part desc”) includes a brief textual description of the part. Again, the legacy textual description is likely to employ jargon such as abbreviations and acronyms that are not readily understood by those who are not intimately familiar with the machine. For each of the parts, a “quantity description” column 56 (“quantity”) identifies the number of the corresponding parts for the machine, assembly and/or sub-assembly. A “unit of measure” column 58 (“UM”) identifies the units of measure in which the quantity is specified. For example, the unit of measurement can be “each” (“EA”) referring to each individual part. An “MPL item number” column 60 (“MLI”) contains a part identifier from the original master parts list. In many cases, the part identifier is the only piece of part information that is not lost or changed as the master parts list evolves into the bill of materials. A “distribution code” column 62 (“code”) identifies a distribution code for the part. A “category identifier” column 64 (“category”) identifies a category to which the part belongs. For example, a part may form a portion of a stator (“S”) of a turbine.

FIG. 3 also shows a portion of a translation data structure 66 for company's machines. The translation data structure 66 is illustrated as a translation table 68 including parts information for the various parts, assemblies and/or sub-assemblies. The parts identification and tracking system 10 generates the translation data structure from the bill of materials data structure 40, with or without human assistance. A single translation data structure 66 can store all the parts information for one or more machines. Thus, the company can make available a single parts listing for each of its products.

The translation table 68 includes a number of rows 70 corresponding to each of the individual parts and/or groups of parts. The translation table 68 also includes a number of columns for detailing information regarding each of the parts. Several of these columns are similar to the columns from the bill of material table 42. For example, an “MPL item number” column (“MLI”) 72 is similar to the “MPL item number” column 60 of the bill of material table 42, containing the part identifier from the original master parts list. A “distribution code” column 74 (“code”) is similar to the “distribution code” column 62 of the bill of materials table 42, containing a distribution code for the part. A “category identifier” column 76 (“category”) is similar to the “category identifier” column 64 of the bill of materials table 42, containing an identifier corresponding to the category to which the part belongs. Additionally, the translation table 68 includes a “title” column 78 (“title”), containing a title for the part. The translation table 68 also includes a “plain language title” column 80 (“Extranet Title if different from title”) containing a plain language version of the title or description of the part. The plain language version of the title or description is written to clearly identify the part to those who would likely be searching for the part, such as a technician or repair person.

The parts identification and tracking system 10 employs a user interface (“UI”) for allowing users, such as technicians and repair persons, to identify and/or order replacement parts. The parts identification and tracking system 10 implements the UI functionality in software which can reside on the server computing system 14 and/or the client computing system 12. For example, the UI can take the form of a Web site having one or more Web pages hosted on the server computing system 14. The Web pages are transmitted to the client computing systems 12 in response to requests placed by Web browsers executing on the client computing systems 12. Alternatively, the UI can take the form of one or more screens stored in the memory 38 of the client computing system 12, or the server computing system 14.

In response to a user query made via the UI, the server computing system 14 makes one or more database quires of the bill of materials data structure 40 and the translation data structure 66 to generate a response providing requested parts information. The response can take the form of a response data structure 82. The response data structure 82 is illustrated as a response table 84, although other formats may be suitable.

The response table 84 includes a number of rows 86 corresponding to parts and groups of parts satisfying the parameters of the user query. The response table 84 also includes a number of columns for detailing information regarding each of the parts. For example, a “title” column 88 (“Title”) includes a title for the part or group of parts. A “part number” column 90 (“Part #”) includes the corresponding identifier from the “parent” column 48 or “child part identifier” column 52 of the bill of material table 42. A “bill of material quantity” column 92 (“BOM qty”) includes the corresponding number of parts from the “quantity description” column 56 of the bill of material table 42.

An “assembly” column 94 identifies whether the corresponding row identifies an individual part or a group of parts (e.g., assembly, sub-assembly). For example, if a row such as row 96 includes a checkbox 98 in the “assembly” column 94, the row 96 corresponds to a group of parts. Otherwise, the row 86 corresponds to an individual part. The user can select the checkbox 98 to view the individual parts of the group of parts. A check 100 in the checkbox 98 provides a visual indication that the user has selected the checkbox 98. A notation “Part Break down” in row 102 indicates that the parts that follow belong to the group of parts.

Some or all of the information from the response data structure 82 can be provided to the user, for example via the display 20 of the client computing system 12. The plain language title 80 provided in the translation table 68 allows people unfamiliar with the precise naming convention employed by designers of the machine to successfully search the parts information.

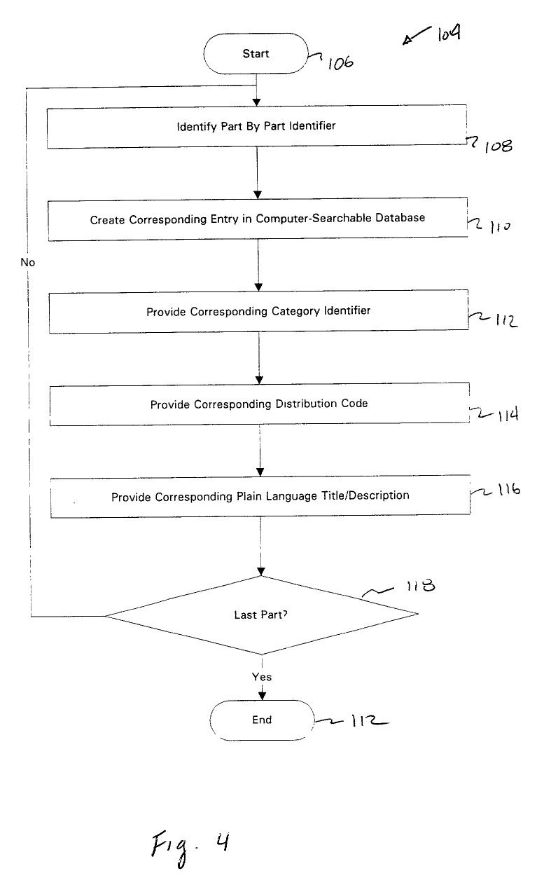

FIG. 4 shows a method 104 of providing legacy parts information in a computer-searchable form, that begins at a start step 106. The method 104 may employ legacy parts information in electronic form, or may require the conversion of legacy parts information from paper form to electronic form, for example by keying or scanning. In particular, FIG. 4 shows the creation of the translation data structure 66 of FIG. 3.

In step 108, the parts identification and tracking system 10 identifies a part using a part identifier. For example, the parts identification and tracking system 10 can employ the MPL item number from the “MPL item number” column 60 of the bill of material table 42 (FIG. 3). In step 110, the parts identification and tracking system 10 creates an entry in the computer-searchable database 34 (FIG. 1) corresponding to the part.

In step 112, the parts identification and tracking system 10 provides a category identifier in the computer-searchable database 34. The category identifier identifies a category to which the part belongs, if any. For example, the parts identification and tracking system 10 can employ the category identifier from the “category identifier” column 64 of the bill of material table 42 (FIG. 3). This allows a user to quickly identify a needed part based on the part's functionality within a system or subsystem. For example, all stator related parts can be rapidly identified.

In step 114, the parts identification and tracking system 10 provides a distribution code the computer-searchable database 34. The distribution code can identify a salable part or group of parts as a salable unit, filtering out non-salable items from the machine parts list or bill of material such as raw material, manufacturing operations, manufacturing processes and strategic parts not intended to be sold as stand alone parts. For example, the parts identification and tracking system 10 can employ “distribution code” column 62 of the bill of materials table 42 (FIG. 3). This is particularly useful where the parts are intended to be sold via electronic commerce. The parts identification and tracking system 10 can ensure that the user only selects parts in predefined packages. This results in the user receiving all of the parts necessary for a particular repair or rehabilitation job. This also permits the company to pre-package parts, which can later be easily and quickly shipped upon request.

In step 116, the parts identification and tracking system 10 provides a plain language title and/or description in the computer-searchable database 34. The plain language title can be entered by a human, or the parts identification and tracking system 10 can automatically generate the plain language title/description by automatically substituting plain language words for previously defined jargon such as abbreviations and acronyms.

In step 118, the parts identification and tracking system 10 determines if all of the parts for the machine have been entered into the translation data structure 66. If last part has been entered, the method 104 terminates at an end step 120. If not, control returns to step 108 for creating an entry in the translation data structure 66 for the next part.

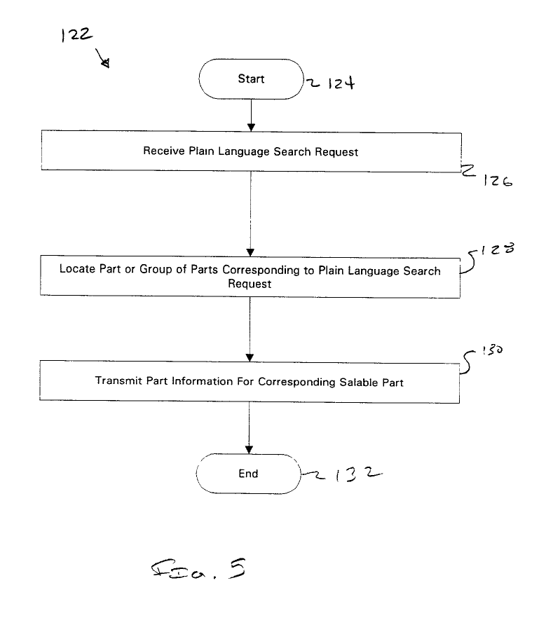

FIG. 5 shows a method 122 of accessing parts information, that starts at step 124. In step 126, the parts identification and tracking system 10 receives a search request in the form of a plain language parts description. For example, a user can submit a plain language description of the part to the server computing system via the keyboard and/or mouse of the client computing system. In step 128, the parts identification and tracking system 10 automatically locates at least one machine part that corresponds to the received plain language parts description. For example, the server computing system 14 can employ a database query of the “plain language title” column 80 of the translation table 68 (FIG. 3). In step 130, the parts identification and tracking system 10 transmits part information to the user for a corresponding salable part. For example, the server computing system 14 can transmit parts information as Web page to the client computing system 12. The method 122 terminates at end step 132.

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other parts tracking and distribution systems, not necessarily the exemplary machine parts tracking and distribution system generally described above. For example, the teachings can be employed with a tracking and identification system for products other than machines. The various embodiments described above can be combined to provide further embodiments. The system can employ communications channels other than the Internet, for example LANs, or WANs. Additionally, or alternatively, the described methods can omit some steps, can add other steps, and can execute the steps in other orders to achieve the advantages of the invention.

These and other changes can be made to the invention in light of the above detailed description. In general, in the following claims, the terms used should not be construed to limit the invention to the specific embodiments disclosed in the specification, but should be construed to include all computers, networks and distribution systems that operate in accordance with the claims. Accordingly, the invention is not limited by the disclosure, but instead its scope is to be determined entirely by the following claims.

1. A method of providing legacy data in a searchable form, comprising:
for a first set of legacy machine parts information, identifying each of a number of unique parts by a respective part identifier;
for each of the identified unique parts, creating an entry in a computer searchable database corresponding to the part; and
providing a category identifier in the computer searchable database for each of the identified unique parts that identifies at least one machine subassembly to which the part belongs.

2. The method of claim 1, further comprising:
providing a distribution code in the computer searchable database for each of the identified unique parts that identifies at least one salable unit to which the part belongs.

3. The method of claim 1, further comprising:
providing a plain language title in the computer searchable database for each of the identified unique parts that identifies the part.

4. The method of claim 1, further comprising:
providing a distribution code in the computer searchable database for each of the identified unique parts that identifies at least one salable unit to which the part belongs; and
providing a plain language title in the computer searchable database for each of the identified unique parts that identifies the part.

5. A method of providing legacy data in a searchable form, comprising:
for a first set of legacy machine parts information, identifying each of a number of unique parts by a respective part identifier;
for each of the identified unique parts, creating an entry in a computer searchable database corresponding to the part; and
providing a distribution code in the computer searchable database for each of the identified unique parts that identifies at least one salable unit to which the part belongs.

6. The method of claim 5, further comprising:
providing a category identifier in the computer searchable database for each of the identified unique parts that identifies at least one machine subassembly to which the part belongs.

7. The method of claim 5, further comprising:
providing a plain language title in the computer searchable database for each of the identified unique parts that identifies the part.

8. A method of providing legacy data in a searchable form, comprising:
for a first set of legacy machine parts information, identifying each of a number of unique parts by a respective part identifier;
for each of the identified unique parts, creating an entry in a computer searchable database corresponding to the part; and
providing a plain language title in the computer searchable database for each of the identified unique parts that identifies the part.

9. A method of facilitating access to legacy data, comprising:
providing a database of parts information computer searchable by plain language parts descriptions for a plurality of parts comprising one or more machines, and including a distribution code in the computer searchable database for each of the parts that identifies at least one salable unit to which the part belongs; and
providing a user interface for accessing the parts information by way of the plain language parts descriptions.

10. The method of claim 9 wherein providing a database of parts information includes:
assigning each of the parts to at least one category corresponding to a subassembly of the machine to which the part belongs.

11. The method of claim 9 wherein providing a database of parts information includes:
identifying each of a number of unique parts in a first set of legacy machine parts information by a respective part identifier;
creating an entry in the database of parts information corresponding to the part; and
adding the plain language description to the database of parts information for each of the identified unique parts that identifies the part.

12. The method of claim 9 wherein providing a database of parts information includes:
identifying each of a number of unique parts in a first set of legacy machine parts information by a respective part identifier;
creating an entry in the database of parts information corresponding to the part;
converting a jargon description of the part from the first set of legacy machine parts information into the plain language description for each of the identified unique parts; and
adding the plain language description to the database of parts information for each of the identified unique parts that identifies the part.

13. A method of accessing machine parts information, comprising:
receiving a search request in the form of a plain language parts description;
automatically locating at least one machine part that corresponds to the received plain language parts description in a computer searchable database of machine parts; and
transmitting item information for at least one salable item that includes the located machine part and at least one other machine part.

14. The method of claim 13 wherein transmitting item information for at least one salable item includes:
transmitting availability information indicating an availability status for the salable item.

15. The method of claim 13 wherein transmitting item information for at least one salable item includes:
transmitting pricing information indicating a sale price for the salable item.

16. The method of claim 13, further comprising:
identifying a distribution code corresponding to the located machine part; and
obtaining the item information based on the identified distribution code.

17. The method of claim 13 wherein automatically locating at least one machine part that corresponds to the received plain language parts description in a computer searchable database of machine parts includes finding a similarity between the received plain language parts description and a title of the at least one machine part.

18. The method of claim 13 wherein automatically locating at least one machine part that corresponds to the received plain language parts description in a computer searchable database of machine parts includes finding a similarity between the received plain language parts description and a title of a subassembly to which the at least one machine part belongs.

19. A computer-readable media whose contents cause a computer system to facilitate access to machine parts information, by:
receiving a search request in the form of a plain language parts description;
automatically locating at least one machine part that corresponds to the received plain language parts description in a computer searchable database of machine parts; and
transmitting item information for at least one salable item that includes the located machine part and at least one other machine part.

20. A system for facilitating access to machine parts information, comprising:
a processor coupled to a computer searchable database of machine parts information and programmed to:
receive a search request in the form of a plain language parts description;
automatically locate at least one machine part that corresponds to the received plain language parts description in the computer searchable database of machine parts; and
transmits item information for at least one salable item that includes the located machine part and at least one other machine part.

21. The system of claim 20, further comprising:
a Web server executing on the processor to receive the search request in the form of an HTTP request.
